(19) United States
(12) Patent Application Publication
(10) Pub. No.: US 2010/0001909 A1
(43) Pub. Date: Jan. 7, 2010

(54) POSITIONING CONDUCTIVE COMPONENTS ADJACENT AN ANTENNA

(76) Inventor: Bjarne Nielsen, Kobenhavn NV (DK)

Correspondence Address: HARRINGTON & SMITH, PC, 4 RESEARCH DRIVE, Suite 202, SHELTON, CT, 06484-6212, US

(21) Appl. No.: 12/312,409

(22) PCT Filed: Nov. 17, 2006
(86) PCT No.: PCT/IB2006/003996

§ 371 Date: May 8, 2009

(51) Int. Cl. H01Q 1/00; H01Q 1/24

(52) U.S. Cl. 343/702; 343/904

(57) ABSTRACT

An apparatus including: an antenna having operational frequencies; and an electrical circuit including a first electrical component adjacent the antenna and a second component for decoupling said electrical circuit from the antenna at the operational frequencies of the antenna.

### FIELD OF THE INVENTION

Embodiments of the present invention relate to positioning conductive components adjacent an antenna.

### BACKGROUND TO THE INVENTION

Antennas are sensitive to the presence of nearby conductive components, particularly grounded components.

It may therefore be difficult to optimize the positioning of conductive components as there may be a ‘forbidden’ region in the vicinity of the antenna where conductive components cannot be placed without significantly compromising the antenna performance.

It would be desirable to position conductive components adjacent the antenna without significantly compromising the antenna performance.

### BRIEF DESCRIPTION OF THE INVENTION

According to one embodiment of the invention there is provided an apparatus comprising: an antenna having operational frequencies; and an electrical circuit comprising a first electrical component adjacent the antenna and a second component for decoupling said electrical circuit from the antenna at the operational frequencies of the antenna.

This provides the advantage that because the electrical circuit is decoupled from the antenna either permanently or when the antenna is in use, the first electrical component may be placed adjacent the antenna thereby saving space and providing greater flexibility in positioning components.

According to another embodiment of the invention there is provided an apparatus comprising: an antenna having operational frequencies; and an electrical circuit comprising a first electrical component adjacent the antenna and at least one inductive component.

### BRIEF DESCRIPTION OF THE DRAWINGS

For a better understanding of the present invention reference will now be made by way of example only to the accompanying drawings in which:

FIG. 1 schematically illustrates an apparatus that automatically decouples electrically conductive components at RF frequencies;

FIG. 2 illustrates a cross-sectional view of a first embodiment of the apparatus taken along the line XY in FIG. 1;

FIGS. 3A and 3B illustrate keypad embodiments;

FIG. 4 schematically illustrates a handset apparatus comprising a keypad; and

FIG. 5 illustrates a cross-sectional view of a second embodiment of the apparatus taken along the line XY in FIG. 1.

### DETAILED DESCRIPTION OF EMBODIMENTS OF THE INVENTION

FIG. 1 schematically illustrates an apparatus 2 that automatically decouples electrically conductive components 12 at RF frequencies.

The apparatus 2 may be incorporated into a module for radio equipment 100 or may be incorporated into a radio terminal 100 such as a mobile cellular telephone handset, for example as illustrated in FIG. 5.

The apparatus 2 comprises: an antenna 4 and a plurality of electrical circuits 10 arranged as an array 11.

The antenna 2 may, for example, be a monopole antenna or an inverted F antenna, such as a planar inverted F antenna (PIFA).

The antenna 4 has a range or ranges of operational frequencies. Each range or band of frequencies has a lower frequency and an upper frequency. The operational resonant frequency range (or ranges) may correspond with one (or more) of the cellular communication bands, such as: US-GSM 850 (824-894 MHz); EGSM 900 (880-960 MHz); PCN/DCS1800 (1710-1880 MHz); US-WCDMA1900 (1850-1990) band; WCDMA21000 band (Tx: 1920-19801 Rx: 2110-2180); and POS 1900 (1850-1990 MHz)

Each of the plurality of electrical circuits 10 comprises a first electrically conductive component 12 adjacent the antenna 4 and second components 14 for decoupling the electrical circuit 10 from the antenna 4 at the operational frequencies of the antenna 4.

The first electrically conductive components 12 may be, for example, separated from the antenna by less than 10 mm.

Each electrical circuit 10 has an in-connection 16 that leads to a first electrical component 12 and an out-connection 18 that leads from the first electrical connection 12. A second component 14 is positioned in series with the in-connection 16 and another second component 14 is positioned in series with the out-connection 18. There could, in other implementations be more connections than an in and an out connection.

The electrical circuit 12 may include a connection 21 to another item, in the example illustrated, the connection is to ground.

A second component 14 may be an electrical component network whose topology is variable dependent on the amount of decoupling/filtering that maybe required for a given communication system. The second component 14 could be, as an example, as simple as a single series inductor or could be, as another example, a T-network consisting of 2 series inductors and a shunt capacitor. A single series inductor may be implemented as a passive inductive component such as a lumped inductor coil. Such an inductive component may, for example; have an inductance between 100 and 120 nH.

The inductive component 14 may be a coil having a self-resonant frequency greater than 1500 MHz and possibly close to the resonant operational frequency of the antenna 4. An example of an inductive component is the Murata LQW15ANR12J00.

Each second component 14 is arranged to suppress electrical currents within the respective electric circuit 10 at the operational radio frequencies of the antenna 4, for example, by having an impedance of the order of 1 kOhm at the operational frequencies of antenna 4. The second components 14 RF de-couple the circuit 10 to the antenna-side from the circuit 10 to the other side. Thus an electric current at the operational frequencies of the antenna 4 cannot readily flow around the circuit 10 because of the impedance provided by the second components. This suppression or breaking of the electrical current in the electrical circuit 10 at the operational frequencies of the antenna 4 ‘decouples’ the electrical circuit 10 from the antenna 4 when the antenna 4 is in use.

Each second component 14 has relatively low impedance at d.c. and high impedance at RF frequency such as the operational frequencies of the antenna. Consequently, the electrical circuit 10 has relatively low impedance at d.c. and high impedance at RF frequency such as the operational frequencies of the antenna The first electrically conductive components 12 and electrical circuits 10 are operational at d.c.

Each electrical circuit 10 comprises some capacitance either as a parasitic capacitance or a lumped capacitor component. The inductive second component(s) 14 and the series connected capacitance create a lossy resonant circuit. The electrical circuit 10 has a resonant frequency that is designed to fall beneath the operation frequency range(s) of the antenna 4.

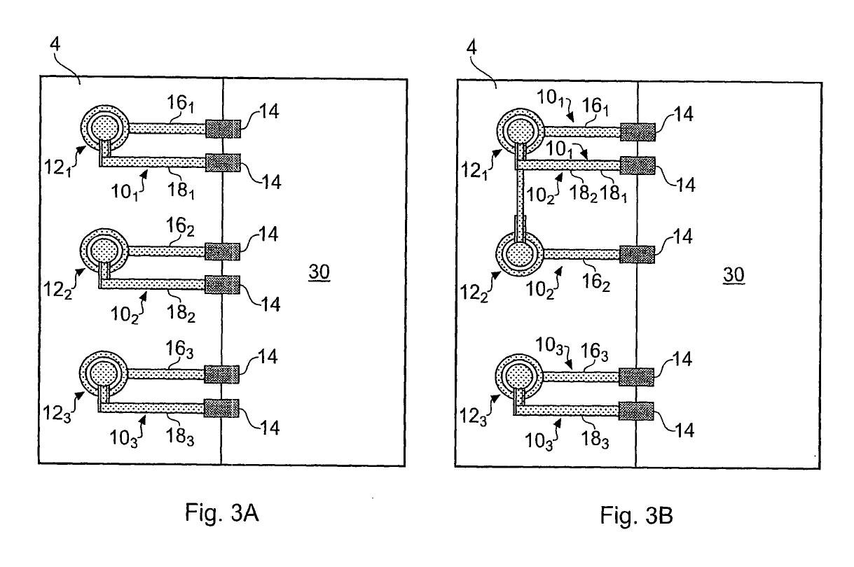

An electrical circuit 10 may include circuitry 20 responsive to the first electrically conductive component 12. In some embodiments, as illustrated in FIGS. 3A and 3B, the first electrically conductive component 12 is a sensor, such as a key-dome switch, that responds to actuation of a key by a user and the circuitry 20 detects the sensor's response. For example, the first electrically conductive component may be a planar metallic key contact which when shorted by another floating piece of metal (the key of the device) creates a change of logic at the circuitry 20.

In FIGS. 3A and 3B the second components 14 are placed at an edge of the ground plane 30

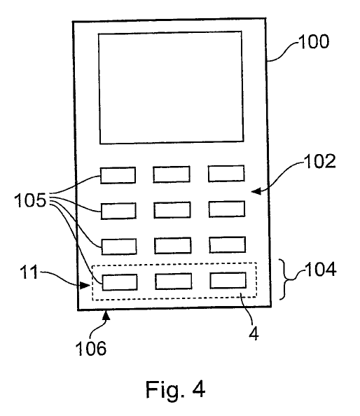

The plurality of first electrically conductive components 12 may be associated with respective keys 105 of a keypad 102 as illustrated in FIG. 4. In this FIG., the antenna 4 is positioned at the base extremity 106 of a handset 100 and because of the presence of the second components 14 the keypad 102 can also be placed towards the base extremity 106 of the handset 100 so that the keypad 102 and antenna 4 overlap in region 104.

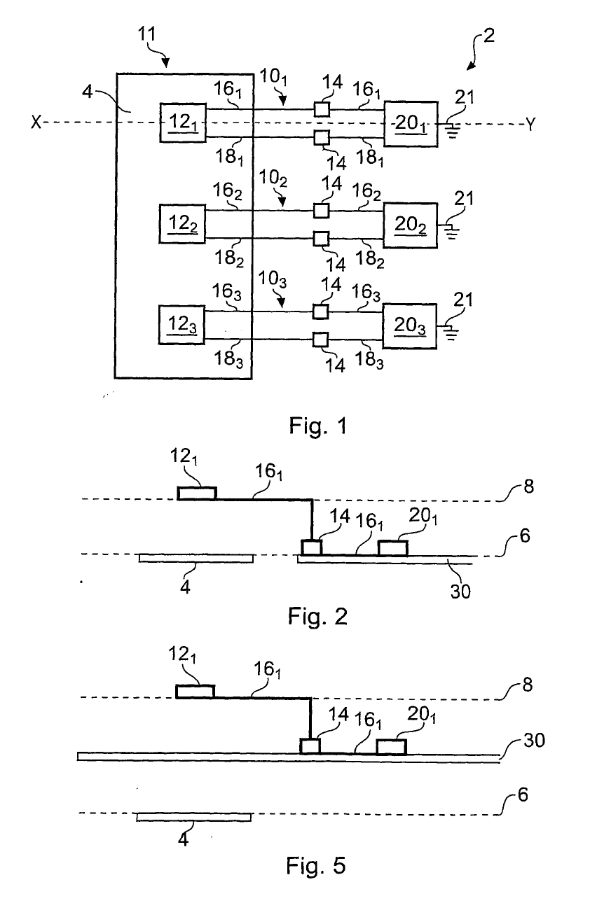

FIG. 2 illustrates a cross-sectional view of the apparatus 10 taken along the line XY in FIG. 1. It can be observed that in this particular implementation the antenna 4 extends predominantly in a first plane 6 and the array 11 of first electrically conductive components 12 lie in a second plane 8 parallel to the first plane 6. The array 11 of first electrically conductive components 12 overlies the antenna 4 and may be associated with a part 104 of the keypad 102.

As illustrated in FIGS. 2, 3A and 3B, the second components 14 may be positioned at an interface between the connections 16, 18 and a circuit board 30.

In circumstances when the circuit board 30 is used as a ground plane for the antenna 4, the circuit board 30 does not intercede between the first electrically conductive components 12 and the antenna 4 as illustrated in FIG. 2.

In circumstances when the circuit board 30 is not used as a ground plane for the antenna 4, the circuit board 30 may intercede between the first electrically conductive components 12 and the antenna 4 as illustrated in FIG. 5. It is also possible that the key 12 is placed on the circuit board 30 in FIG. 5.

Although embodiments of the present invention have been described in the preceding paragraphs with reference to various examples, it should be appreciated that modifications to the examples given can be made without departing from the scope of the invention as claimed. For example, an electrical circuit 10 may comprises a digital microphone or other electrical component 12.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/we claim:

1. An apparatus comprising:
an antenna having operational frequencies; and
an electrical circuit comprising a first electrically conductive component adjacent the antenna and a second component for decoupling said electrical circuit from the antenna at the operational frequencies of the antenna.

2. An apparatus as claimed in claim 1, wherein the first electrically conductive component and first electrical circuit are operational at d.c.

3. An apparatus as claimed in claim 1, wherein the electrical circuit is relatively low impedance at d.c. and relatively high impedance at RF frequencies

4. An apparatus as claimed in claim 1, wherein the electrical circuit has an in-connection having a serially connected second component and an out-connection having a serially connected second component.

5. An apparatus as claimed in claim 1, wherein the electrical circuit includes a ground connection.

6. An apparatus as claimed in claim 1, wherein the electrical circuit has a resonant frequency that is lower than the operation frequencies of the antenna.

7. An apparatus as claimed in claim 1, wherein the electrical circuit is a switching circuit comprising a switch for actuation by a user.

8. An apparatus as claimed in claim 1, wherein the electrical circuit is a sensing circuit for sensing actuation of a key.

9. An apparatus as claimed in claim 1, comprising a plurality of electrical circuits each comprising a first electrically conductive component adjacent the antenna and a second component for decoupling the electrical circuit from the antenna at the operational frequencies of the antenna.

10. An apparatus as claimed in claim 9, wherein the first electrically conductive components are switches of a keypad.

11. An apparatus as claimed in claim 10, wherein the antenna extends predominantly in a first plane and the keypad switches lie in a second plane parallel to the first plane and overlie the antenna.

12. An apparatus as claimed in claim 1, wherein the second component is arranged to suppress electrical currents having a frequencies similar to the operational frequencies of the antenna.

13. An apparatus as claimed in claim 1, wherein the second component is arranged to suppress electrical currents having a RF frequency.

14. An apparatus as claimed in claim 1, wherein the second component is arranged to suppress electrical currents between a lower frequency and an upper frequency.

15. An apparatus as claimed in claim 1, wherein the second component is a passive component.

16. An apparatus as claimed in claim 1, wherein the second component has an impedance of the order 1 kOhm at the operational frequencies of the antenna.

17. An apparatus as claimed in claim 1, wherein the second component is a series connected inductive component.

18. An apparatus as claimed in claim 1, wherein the second component has an inductance greater than 100 nH.

19. An apparatus as claimed in claim 1, wherein the second component is an inductive coil having a self-resonant frequency greater than 1500 MHz.

20. An apparatus as claimed in claim 1, wherein the second component is an inductive coil having a self-resonant frequency close to the operational frequencies of the antenna.

21. An apparatus as claimed in claim 1, further comprising a circuit board carrying the second components.

22. An apparatus as claimed in claim 1, further comprising a circuit board that operates as a ground plane for the antenna and is positioned so that it does not lie between the antenna and the first electrically conductive component.

23. An apparatus as claimed in claim 1, further comprising a circuit board that does not operate as a ground plane for the antenna and is positioned so that it lies between the antenna and the first electrically conductive component.

24. An apparatus as claimed in claim 1, wherein the antenna is a monopole.

25. An apparatus as claimed in claim 1, wherein the antenna is an inverted F antenna.

26. An apparatus as claimed in claim 1, wherein the antenna is located at an extremity of a handset.

27. A module for radio equipment comprising the apparatus as claimed in claim 1.

28. A radio comprising the apparatus as claimed in claim 1.

29. A mobile cellular telephone handset comprising the apparatus as claimed in claim 1.

30. An apparatus comprising:
an antenna having operational frequencies; and
an electrical circuit comprising a first electrically conductive component adjacent the antenna and at least one inductive component.
